(19) United States
(12) Patent Application Publication
(10) Pub. No.: US 2017/0200095 A1
(43) Pub. Date: Jul. 13, 2017

(54) SMART REROUTING INFRASTRUCTURE FOR TRAVELERS

(71) Applicant: International Business Machines Corporation, Armonk, NY (US)

(72) Inventors: Kulvir S. Bhogal, Fort Worth, TX (US); Herbert Barrientos Carvajal, Sabanilla de Montes de Oca (CR); Rick A. Hamilton, II, Charlottesville, VA (US); Agueda Martinez Hernandez Magro, Zapopan (MX)

(21) Appl. No.: 14/990,188

(22) Filed: Jan. 7, 2016

(51) Int. Cl. G06Q 10/02; G06Q 50/14

(52) U.S. Cl. CPC G06Q 10/02; G06Q 50/14

(57) ABSTRACT

A system, method and program product for providing rerouting options for airline travelers. A system is disclosed that includes: a passenger scanning system that detects enabled mobile devices in geospatial zones associated with a plurality of airports; a passenger management system that verifies passengers associated with detected enabled mobile devices, retrieves itineraries for verified passengers, and handles communications with verified passengers; an itinerary management system that monitors for special conditions associated with retrieved itineraries and handles itinerary modifications in response to identified special conditions; and a passenger database that stores state information for each verified passenger.

### TECHNICAL FIELD

The subject matter of this invention relates to rerouting of travelers using public transportation, and more particularly to a system and method of rerouting airline travelers based on transit conditions and available options.

### BACKGROUND

Managing passenger traffic in complex public transportation systems, such as with airlines, represents a significant challenge. For example, air carriers routinely overbook flights to account for “no shows.” With this practice, airlines schedule more passengers than a flight can hold, under the assumption that a certain number of passengers will not show up for the flight. This policy can be beneficial for the airline when the number of “no-shows” is large, but is also costly when all travelers show up. In such situations, airlines offer incentives to persuade travelers to go on different flights voluntarily and in a worst case, they bump passengers in exchange for compensation. This compensation is absorbed by the airline.

Furthermore, different situations can cause a flight to be delayed or cancelled, such as weather, mechanical problems, and late flight crew arrivals. Such delayed or cancelled flights cause stress and problems for travelers, such as wasted time, missed connections, and added expense. In a typical month, it is not unusual to have over 50,000 cancelled flights and 500,000 delayed flights worldwide.

Accordingly, various challenges exist with managing airline passenger traffic in an environment where flights can be overbooked or under booked, and delays and cancellations are common. In addition to the inconvenience of the passengers, there is a significant economic impact. For example, while the cost of bumping passengers can be variable, it is often considerable. Alternatively, the cost to the airlines of semi-empty flights is also considerable. Air carriers must thus attempt to maximize expected income by balancing each of these expected costs.

Unfortunately, current airline reservation systems offer little flexibility to alter or reroute passenger traffic to effectively balance the needs of the airlines and passengers in light of the aforementioned constraints. For example, consider the following scenario. Airline “A” has a 5:45 PM flight from Miami to Washington which has 12 empty seats. Airline “B” has a 6:00 PM flight from Miami to Washington, which is overbooked by four passengers. In today's current state of the art, the first flight departs with empty seats, while the second flight suffers from the costs associated with overbooking. This results in lower customer satisfaction, and lower revenues for each of the affected airlines.

### SUMMARY

Aspects of the disclosure provide an infrastructure for notifying travelers, via mobile devices, of potential conditions that might impact a traveler's itinerary and for offering alternative arrangements. Doing so mitigates problems of overbooking, and allows passengers better manage or avoid delayed or cancelled flights.

A first aspect discloses a rerouting system that provides rerouting options to airline passengers, comprising: a passenger scanning system that detects enabled mobile devices in geospatial zones associated with a plurality of airports; a passenger management system that verifies passengers associated with detected enabled mobile devices, retrieves itineraries for verified passengers, and handles communications with verified passengers; an itinerary management system that monitors for special conditions associated with retrieved itineraries and handles itinerary modifications in response to identified special conditions; and a passenger database that stores state information for each verified passenger.

A second aspect discloses a computer program product stored on a computer readable storage medium, which when executed by a computing system, provides rerouting options to airline passengers, the computer program product comprising: programming logic that tracks detected enabled mobile devices in geospatial zones associated with a plurality of airports; programming logic that verifies passengers associated with detected enabled mobile devices, retrieves itineraries for verified passengers, and handles communications with verified passengers; programming logic that monitors for special conditions associated with retrieved itineraries and handles itinerary modifications in response to identified special conditions; and programming logic that maintains a passenger database of state information for each verified passenger.

A third aspect discloses a method for providing rerouting options to airline passengers, comprising: detecting enabled mobile devices in geospatial zones associated with a plurality of airports; verifying passengers associated with detected enabled mobile devices; retrieving itineraries for verified passengers; monitoring for special conditions associated with retrieved itineraries; proposing alternative itineraries in response to identified special conditions; and generating a modified reservation in response to an acceptance of a proposed alternative itinerary.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having a rerouting system according to embodiments.

FIG. 2 shows a flow diagram of a rerouting process according to embodiments.

FIG. 3 depicts a passenger database according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

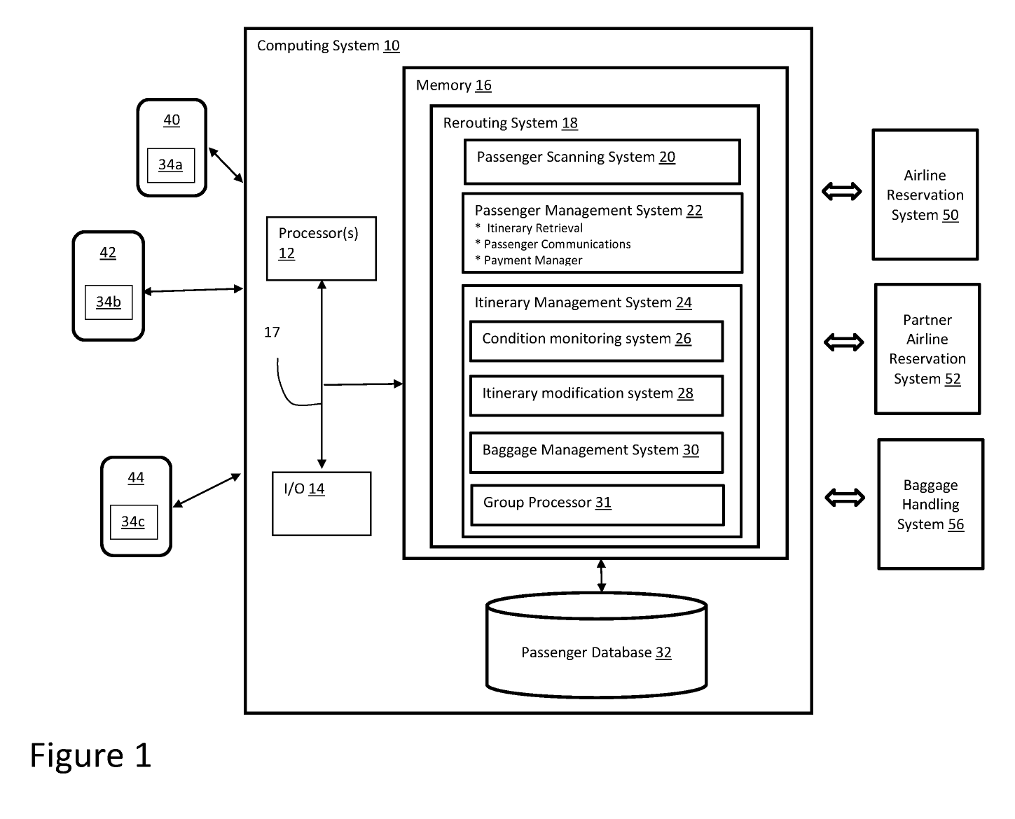

Referring now to the drawings, FIG. 1 depicts a computing system 10 having a rerouting system 18 for dynamically rerouting passengers engaged in airline travel. Note that while this disclosure is generally directed at airline travel, the described infrastructure could likewise be used for other types of travel, e.g., rail travel. In one illustrative embodiment, rerouting system 18 is implemented as a service that users can participate in by, for example, registering with the service and downloading or otherwise accessing an associated application (App) 34a, 34b, 34c, via a mobile device 40, 42, 44. As detailed herein, the rerouting service will detect passengers in airports and identify special conditions that might impact a passenger's itinerary and offer alternative arrangements.

Rerouting system 18 generally includes: a passenger scanning system 20 that identifies passengers in or near an airport by detecting mobile devices 40, 42, 44; a passenger management system 22 that manages passenger specific interactions once a passenger is detected; and an itinerary management system 24 that identifies problematic travel conditions and rerouting options for verified passengers.

Passenger scanning system 20 may for example use GPS (global positioning system) or any other location based services to detect “enabled” mobile devices 40, 42, 44, in predefined geospatial zones that are running an App 34a, 34b, 34c associated with rerouting system 18. More particularly, passenger scanning system 20 detects enabled devices 40, 42, 44 that are located in or near (i.e. associated with) airports, in an attempt to identify users (i.e., passengers) who are registered with the rerouting system 18 and who are scheduled to board an upcoming flight.

Once an enabled mobile device 40, 42, 44 is detected, a verification process is initiated to make sure the user operating the mobile device 40, 42, 44 is a registered user, and that the user is indeed a traveler on an upcoming flight (and not at the airport for some other reason, e.g., a drop-off or pick-up). The verification process may for example be initiated with a notification (e.g., a text, a displayed message, etc.) requesting the user to launch the App 34a, 34b, 34c, enter a credential such as a password or, e.g., thumb, facial or voice recognition input, and confirm the user is a passenger on an upcoming flight.

Once a passenger is identified (i.e., detected and verified), passenger management system 22 manages communications with the passenger via the detected mobile device 40, 42, 44 and creates or updates a passenger record in the passenger database 32, which among other things, tracks a “state” of each identified passenger. In addition, once identified, passenger management system 22 retrieves itinerary information for the passenger. Itinerary information may be obtained in any manner, e.g., from the passenger (e.g., via an entered confirmation number), via an associated airline reservation system 50, from previously collected information from the passenger, from a third party service, or some combination thereof. In one embodiment, the retrieved itinerary only includes flights beginning from where the passenger is currently located. Accordingly, in a multi-legged trip that passes through several airports, a new itinerary is retrieved at each airport traversed by the passenger.

Once obtained, itinerary management system 24 analyzes the itinerary to determine potential problematic travel (i.e., “special”) conditions and rerouting options. Itinerary management system 24 generally includes: a condition monitoring system 26 that determines if there are any special conditions such as delays or flight cancellations for a given itinerary; an itinerary modification system 28 for modifying a passenger's itinerary; and a baggage management system 30 for rerouting baggage in the event of an itinerary change. In addition, itinerary management system 24 may include a group processor 31 for handling groups traveling together.

Condition monitoring system 26 may utilize any evaluation criteria to determine if a “special” condition exists. Illustrative conditions include: an overbooked flight, a delayed flight, a canceled flight, a flight with a tight connection, a waitlist condition, a staff/family space availability situation (SUBLO), upgrade availability, cost, etc. Evaluation criteria may be defined by the rerouting system 18 and/or the user, e.g., based on user preferences.

In the event a special condition exists, itinerary modification system 28 will attempt to identify rerouting options to address or overcome the condition. For instance, assume a passenger is traveling from airports A to B to C. If the upcoming flight from A to B is having a flight delay that might cause the passenger to miss the connection from B to C, itinerary modification system 28 will check to see if there are available rerouting options. Assuming an alternative itinerary is available (e.g., A to D to C), the option (or set of options) is presented to the passenger. In the event that multiple passengers qualify for a potential alternative itinerary, a priority queue may be implemented. Priority may be based on the seat type (e.g., first class, business class, coach, etc.), frequent flier status, special needs, group travelers, etc.

If the passenger accepts an available alternative itinerary, itinerary modification system 28 will rebook the passenger with a modified itinerary. In the event there is a cost involved with the change, e.g., a seat upgrade, passenger management system 22 may include a payment manager to handle payment from the mobile App 34a, 34b, 34c.

In one embodiment, itinerary modification system 28 will first look for alternative itineraries on the airline reservation system 50 of the airline on which the passenger was originally booked. If no alternatives exist, itinerary modification system 28 will look at partner airline reservations systems 52 for potential alternative itineraries. Depending upon the implementation and conditions, itinerary modification system 28 may look at a competitor's airline reservation system as a final option.

Furthermore, if an itinerary contains flights serviced by carriers not part of the original airline's partner group (i.e., competitors), itinerary modification system 28 may propose itinerary changes starting at the airport where the passenger is located, and up to the flight that is serviced by a competitor. If the itinerary contains any remaining flights to be serviced by the original airline, or any of the partner airlines, but which come after the flight serviced by the competitor, then that part of the itinerary may be processed for changes once the competitor's flight is complete (i.e., the passenger will be located at the airport where the competitor carrier took him/her).

Regardless, if the passenger accepts an alternative itinerary, baggage management system 30 will determine if the passenger has checked baggage, and if so, will alert baggage handling system 56 to reroute the passenger's bags. In some instances, baggage management system 30 may be queried earlier in the process to determine whether or not baggage rerouting is possible. For instance, if the baggage is already loaded onto a plane, it may be too late to reroute it. In such a case, the user may be given the option to proceed with an itinerary change knowing that any baggage will be delayed, or stay with the original itinerary.

As noted, itinerary management system 24 may include a group processor 31 for handling situations where multiple people are identified as a group traveling together (e.g., a family, a tour, etc.). In this situation, one of the passengers of the group may be identified as the “group leader.” In such an embodiment, communications for possible itinerary modification may be limited to just the group leader. In the event a special condition exists, the group leader can request alternatives that will accommodate the entire group, or a predetermined part of the group.

As noted, passenger database 32 is utilized to store information associated with each identified passenger. In order to track each passenger not only within an airport, but potentially in a sequence of airports, the rerouting system 18 maintains a “state” of each enabled device/passenger. Illustrative states may for example include:
(0) Not Verified: An enabled mobile device has been detected by passenger scanning system 20, but the user has not yet been identified or verified by the system.
(1) Verified: The user of the mobile device has been identified and verified by the system.
(2) Special Condition Exists/No resolution: A special condition with the passenger itinerary was detected, but the system was not able to provide an alternative flight solution or the passenger did not accept the available option(s). Under this state, the passenger may be periodically contacted again by the system.
(3) Resolution Provided/At the same Airport: A special condition with the passenger itinerary was detected, the system was able to provide an alternative flight solution that the passenger accepted, and the passenger is at the same airport where the solution was given. Under this state, the passenger will not be contacted again by the system.
(4) Resolution Provided/Different Airport: A special condition with the passenger itinerary was detected, the system was able to provide an alternative flight solution that the passenger accepted, and the passenger is now at or in-route to a different airport from where the solution was given. Under this state, contact with the passenger will initiate again.

In addition to storing state and itinerary information about active passengers, passenger database 32 may also store preferences for passengers such as airline preferences, seat preferences, route preferences, etc., based, on historical usage, user registration information, natural language queries, etc. Preferences may be used to tailor rerouting options for each passenger. For example, if it is known that a passenger is often willing to pay for an upgrade to first class, the system may look for first class seating options on alternative routes. Passenger database 32 may also store mobile device IDs and track passengers from airport to airport to maintain a current location of each passenger.

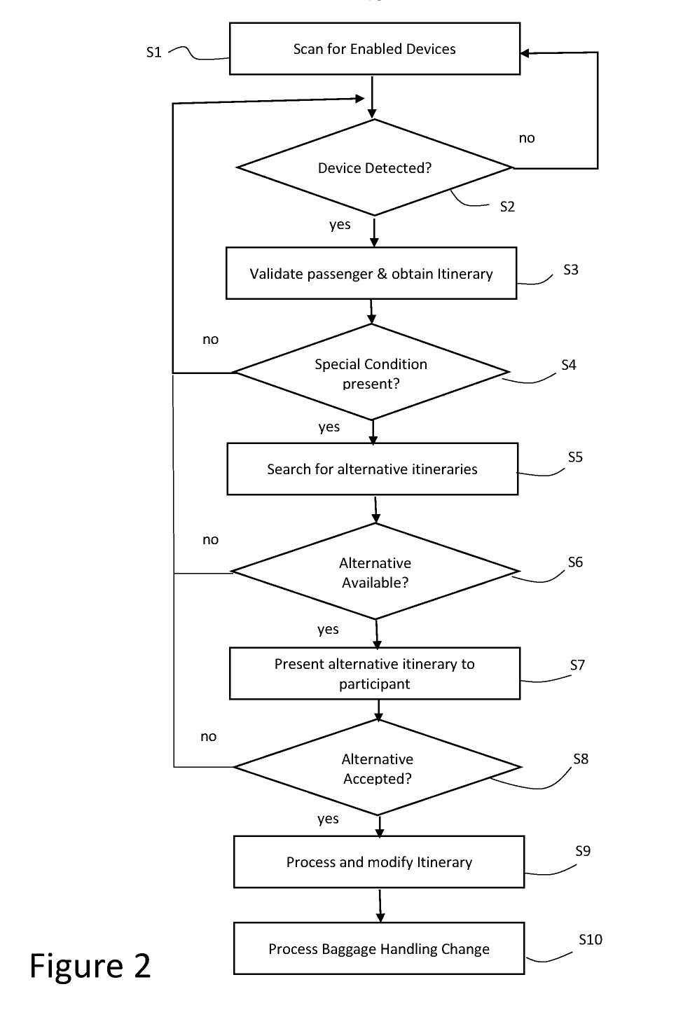

FIG. 2 depicts a flow diagram of a rerouting process. At S1, rerouting system 18 continually scans a zone (e.g., an airport, a terminal, a radius, etc.) for enabled mobile devices 40, 42, 44. When a device is detected at S2, the associated user/passenger is validated based on a submitted credential and the passenger's itinerary is obtained at S3. At S4, a determination is made whether there are any special conditions associated with the passenger itinerary. If no, the process loops back and repeats periodically. Alternatively, the process may simply end with the assumption that no special conditions will arise. If a special condition is detected at S4, then the process searches for alternative itineraries at S5 that will address the special condition. If no alternatives exist, the process loops back and repeats periodically. Alternatively, the process may simply end with the assumption that no alternatives will become available.

If one or more alternatives are available at S6, they are presented to the passenger at S7. At S8, the passenger can accept or reject the alternative(s). If rejected, the process loops back and repeats periodically. Alternatively, the process may simply end with the assumption that the passenger will not accept any alternatives that become available. If an alternative is accepted, a modified itinerary is created for the passenger at S9. Finally, at S10, any baggage handling changes are processed.

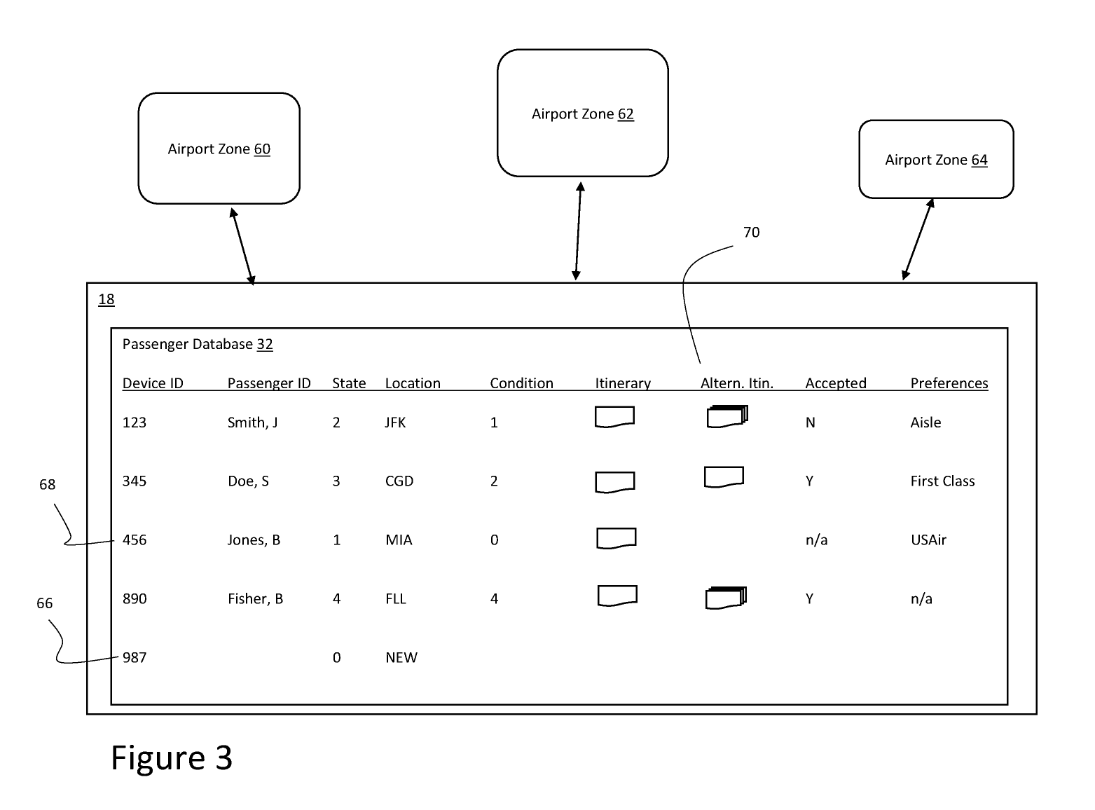

FIG. 3 depicts an illustrative implementation of a passenger database 32 implemented within rerouting system 18. As shown, rerouting system 18 continuously scans for enabled mobile devices/passengers in a plurality of different airport zones 60, 62, 64. Once an enabled mobile device is detected, the information is loaded into the passenger database 32 as a record. For instance record 66 initially just shows the Device ID and airport at which a device was detected, indicating that an associated passenger has not yet been verified (state 0). Once a passenger is verified, itinerary and other information is collected and entered in the record. For example, record 68 shows a situation where a passenger has been verified and no special condition exists (state 1). If special conditions exist, alternative itineraries 70 are located and stored as well. Thus, each record maintains the Device ID, passenger ID, state, airport location, special condition, current itinerary, alternative itinerary(s), whether an alternative itinerary was accepted, and user preferences. It is understood that passenger database 32 shown in FIG. 3 is for illustrative purposes only, and the actual types and amount of data stored therein will depend upon the particular implementation.

It is understood that rerouting system 18 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions, i.e., programming logic, described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 10 that may comprise any type of computing device and for example includes at least one processor 12, memory 16, an input/output (I/O) 14 (e.g., one or more I/O interfaces and/or devices), and a communications pathway 17. In general, processor(s) 12 execute program code which is at least partially fixed in memory 16. While executing program code, processor(s) 12 can process data, which can result in reading and/or writing transformed data from/to memory and/or I/O 14 for further processing. The pathway 17 provides a communications link between each of the components in computing system 10. I/O 14 can comprise one or more human I/O devices, which enable a user to interact with computing system 10. Computing system 10 may also be implemented in a distributed manner such that different components reside in different physical locations.

Furthermore, it is understood that the rerouting system 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A rerouting system that provides rerouting options to airline passengers, comprising:
a passenger scanning system that detects enabled mobile devices in geospatial zones associated with a plurality of airports;
a passenger management system that verifies passengers associated with detected enabled mobile devices, retrieves itineraries for verified passengers, and handles communications with verified passengers;
an itinerary management system that monitors for special conditions associated with retrieved itineraries and handles itinerary modifications in response to identified special conditions; and
a passenger database that stores state information for each verified passenger.

2. The rerouting system of claim 1, wherein the passenger scanning system utilizes a GPS (global positioning system) location service to detect enabled mobile devices.

3. The rerouting system of claim 1, wherein itineraries are retrieved via an airline reservation system.

4. The rerouting system of claim 1, wherein a detected special condition includes a condition selected from a group consisting of: an overbooked flight, a delayed flight, a canceled flight, a flight with a tight connection, a waitlist condition, a staff/family space availability situation, an upgrade availability, and a cost.

5. The rerouting system of claim 1, wherein handling of an itinerary modification includes:
searching for an alternative itinerary at an airline reservation system through which an original itinerary was booked;
presenting the alternative itinerary to the passenger on an enabled mobile device;
in response to the alternative itinerary being accepted, interfacing with the airline reservation system to generate a modified itinerary.

6. The rerouting system of claim 5, further comprising searching for the alternative itinerary at a partner airline reservation system in response to no alternative itinerary being available at the airline reservation system.

7. The rerouting system of claim 5, further comprising a baggage management system for rerouting passenger baggage in response to the alternative itinerary being accepted.

8. A computer program product stored on a computer readable storage medium, which when executed by a computing system, provides rerouting options to airline passengers, the computer program product comprising:
programming logic that tracks detected enabled mobile devices in geospatial zones associated with a plurality of airports;
programming logic that verifies passengers associated with detected enabled mobile devices, retrieves itineraries for verified passengers, and handles communications with verified passengers;
programming logic that monitors for special conditions associated with retrieved itineraries and handles itinerary modifications in response to identified special conditions; and
programming logic that maintains a passenger database of state information for each verified passenger.

9. The computer program product of claim 8, wherein enabled mobile devices are detected with a GPS (global positioning system) location service.

10. The computer program product of claim 8, wherein itineraries are retrieved via an airline reservation system.

11. The computer program product of claim 8, wherein a special condition includes a condition selected from a group consisting of: an overbooked flight, a delayed flight, a canceled flight, a flight with a tight connection, a waitlist condition, a staff/family space availability situation, an upgrade availability, and a cost.

12. The computer program product of claim 8, wherein handling of an itinerary modification includes:
searching for an alternative itinerary at an airline reservation system through which an original itinerary was booked;
presenting the alternative itinerary to the passenger on an enabled mobile device;
in response to the alternative itinerary being accepted, interfacing with the airline reservation system to generate a modified itinerary.

13. The computer program product of claim 12, further comprising searching for the alternative itinerary at a partner airline reservation system in response to no alternative itinerary being available at the airline reservation system.

14. The computer program product of claim 12, further comprising programming logic for rerouting passenger baggage in response to the alternative itinerary being accepted.

15. A method for providing rerouting options to airline passengers, comprising:
detecting enabled mobile devices in geospatial zones associated with a plurality of airports;
verifying passengers associated with detected enabled mobile devices;
retrieving itineraries for verified passengers;
monitoring for special conditions associated with retrieved itineraries;
proposing alternative itineraries in response to identified special conditions; and
generating a modified reservation in response to an acceptance of a proposed alternative itinerary.

16. The method of claim 15, wherein itineraries are retrieved via an airline reservation system.

17. The method of claim 15, wherein a special condition includes a condition selected from a group consisting of: an overbooked flight, a delayed flight, a canceled flight, a flight with a tight connection, a waitlist condition, a staff/family space availability situation, an upgrade availability, and a cost.

18. The method of claim 15, wherein handling of an itinerary modification includes:
searching for an alternative itinerary at an airline reservation system through which an original itinerary was booked; and
searching for the alternative itinerary at a partner airline reservation system in response to no alternative itinerary being available at the airline reservation system.

19. The method of claim 15, further comprising rerouting passenger baggage in response to the alternative itinerary being accepted.

20. The method of claim 15, further comprising storing and maintaining state information of verified passengers in a passenger database.
